(19) United States
(12) Patent Application Publication
(10) Pub. No.: US 2025/0385524 A1
(43) Pub. Date: Dec. 18, 2025

(54) MULTI-UNIT FUEL CELL SYSTEM WITH MICROGRID

(71) Applicant: HYAXIOM, INC., East Hartford, CT (US)

(72) Inventors: George P. Berntsen, Shelton, CT (US); Gene Moir, III, Bloomfield, CT (US)

(21) Appl. No.: 18/740,849

(22) Filed: Jun. 12, 2024

(51) Int. Cl. H02J 3/38; H02J 3/00; H02J 3/14; H02J 3/32; H02J 7/00

(52) U.S. Cl. CPC H02J 3/381; H02J 3/0012; H02J 3/14; H02J 3/32; H02J 3/388; H02J 7/0048; H02J 7/00712; H02J 2203/10; H02J 2300/30; H02J 2310/58

(57) ABSTRACT

A method and system includes a plurality of fuel cell power plants operable to supply power to a utility grid, a connection interface operable to connect the plurality of fuel cell power plants to the utility grid, and an energy storage system operable to store power generated by the plurality of fuel cell power plants. At least one microgrid is connectable to the utility grid with the connection interface. During normal system operation, an energy storage system is operable to connect the at least one microgrid to the utility grid via the connection interface. In response to an occurrence of a predetermined grid event, the energy storage system is operable to disconnect the at least one microgrid from the utility grid and is operable to supply a microgrid load associated with the at least one microgrid. In response to an occurrence of a predetermined grid event, an energy management system is operable to maintain a desired state-of-charge for one or more batteries of the energy storage system by communicating specific power setpoints to the plurality of fuel cell power plants.

### TECHNICAL FIELD

This disclosure relates to a power block comprised of a multi-unit fuel cell system, an energy storage system, an energy management system, and a microgrid.

### BACKGROUND

Power plants comprised of fuel cells are used to provide power to various utility grids comprised of homes, businesses, data centers, etc. A power plant can also be configured to provide power to a microgrid in the event of a loss of power from the utility grid. This independent mode traditionally forces the power plant to instantly follow a load of the customer which may potentially exceed fuel cell transient limits and result in fuel cell degradation.

### SUMMARY

In one example implementation, a system includes: a plurality of fuel cell power plants operable to supply power to a utility grid; a connection interface operable to connect the plurality of fuel cell power plants to the utility grid; an energy storage system operable to store power generated by the plurality of fuel cell power plants, wherein the energy storage system includes one or more batteries; at least one microgrid connectable to the utility grid with the connection interface, wherein the energy storage system is operable to connect the at least one microgrid to the utility grid via the connection interface, and wherein in response to an occurrence of a predetermined grid event, the energy storage system is operable to disconnect the at least one microgrid from the utility grid; and an energy management system, wherein during normal operation, the energy management system is operable to maintain a standby state-of-charge of the one or more batteries of the energy storage system, and in response to the occurrence of the predetermined grid event, the energy management system is operable to maintain a desired state-of-charge of the one or more batteries by controlling power setpoints for the plurality of fuel cell power plants.

In a further non-limiting implementation of any of the systems, the connection interface comprises a static transfer switch.

In a further non-limiting implementation of any of the systems, the energy storage system includes one or more batteries and a power conditioning system.

In a further non-limiting implementation of any of the systems, the one or more batteries comprise lithium ferro-phosphate batteries and the power conditioning system comprises a bi-directional inverter.

In a further non-limiting implementation of any of the systems, wherein, during normal operation, the plurality of fuel cell power plants are operable at a base load up to a rated load per fuel cell and are operable to provide electrical and thermal loads to the utility grid, the energy storage system is operable to maintain the standby state-of-charge, and the energy storage system is operable to monitor for a change in grid status.

In a further non-limiting implementation of any of the systems, in response to the predetermined grid event, the energy storage system is operable to instantly and seamlessly supply a microgrid load while regulating system voltage and frequency.

In a further non-limiting implementation of any of the systems, the predetermined grid event comprises a grid disturbance or outage.

In a further non-limiting implementation of any of the systems, the energy storage system, in response to the predetermined grid event, and the energy management system is operable to simultaneously command the plurality of fuel cell power plants to an idle mode such that the plurality of fuel cell power plants only supply internal parasitic loads, and wherein the energy management system is operable to subsequently send the power setpoints to each fuel cell power plant to supply the microgrid load and is operable to command the plurality of fuel cell power plants to ramp up at a predetermined rate until the power setpoints are reached, such that the energy storage system is operable to stop discharging and maintain a desired state-of-charge.

In a further non-limiting implementation of any of the systems, as microgrid load varies up or down, the energy storage system is operable to immediately produce or absorb power to maintain voltage and frequency, and wherein the energy management system is operable to calculate and communicate updated power setpoints to each fuel cell power plant to maintain the desired state-of-charge for the energy storage system.

In a further non-limiting implementation of any of the systems, the at least one microgrid includes at least one microgrid controller operable to prioritize loads, and wherein, in response to one of the plurality of fuel cell power plants going offline, at least one microgrid controller or the energy management system is operable to command the energy storage system to seamlessly and instantly pick up a load that was carried by an offline fuel cell power plant.

In a further non-limiting implementation of any of the systems, the energy management system is operable to signal to the at least one microgrid controller that a maximum power available has reduced by an amount equal to that previously being provided by the offline fuel cell power plant, and wherein the at least one microgrid controller is operable to identify lower priority loads to shed such that the at least one microgrid continues operating at reduced load capability.

In a further non-limiting implementation of any of the systems, the plurality of fuel cell power plants comprises a predetermined number of fuel cell power plants that is determined to satisfy system operational requirements, and wherein at least one additional fuel cell power plant is added to the system, and wherein each fuel cell power plant has a maximum operating load, and wherein, during normal operation, the energy management system is operable to signal the predetermined number of fuel cell power plants and the at least one additional fuel cell power plant to operate at a reduced operating load that is less than the maximum operating load.

In a further non-limiting implementation of any of the systems, in response to one of the predetermined number of fuel cell power plants and the at least one additional fuel cell power plant going off-line to comprise an off-line fuel cell power plant, the energy storage system is operable to provide power to a microgrid load shed by the off-line fuel cell power plant, and the energy management system is operable to increase operating levels of any remaining fuel cell power plants from the reduced operating load to the maximum operating load such that the energy storage system stops discharging power and maintains a steady-state charge level.

In one example implementation, a method includes: suppling power to a utility grid with a plurality of fuel cell power plants; connecting the plurality of fuel cell power plants to the utility grid via a connection interface; storing power generated by the plurality of fuel cell power plants with an energy storage system including one or more batteries; during normal operation, an energy storage system connects at least one microgrid to a utility grid via the connection interface; and in response to an occurrence of a predetermined grid event, the energy storage system disconnects the at least one microgrid from the utility grid and supplies a microgrid load associated with the at least one microgrid, and an energy management system maintains a desired state-of-charge for the one or more batteries by communicating specific power setpoints to the plurality of fuel cell power plants.

In a further non-limiting implementation of any of the methods, wherein the predetermined grid event comprises a grid disturbance or outage, and wherein, in response to the predetermined grid event, the energy storage system:

immediately supplies the microgrid load while regulating system voltage and frequency, while also simultaneously commanding the plurality of fuel cell power plants to an idle mode such that the plurality of fuel cell power plants are supplying internal parasitic loads; and

subsequently sends power setpoints to each fuel cell power plant to supply the microgrid load and commands the plurality of fuel cell power plants to ramp up at a predetermined rate until the power setpoints are reached, and such that the energy storage system stops discharging and maintains the desired state-of-charge.

In a further non-limiting implementation of any of the methods, as microgrid load varies up or down, the energy storage system immediately produces or absorbs power to maintain voltage and frequency, and including calculating and communicating updated power setpoints to each fuel cell power plant as necessary to maintain the desired state-of-charge for the energy storage system.

In a further non-limiting implementation of any of the methods, in response to one of the plurality of fuel cell power plants going offline to comprise an offline fuel cell power plant, the energy storage system seamlessly and instantly picks up a portion of the microgrid load that was being carried by the offline fuel cell power plant, and including signaling at least one microgrid controller that a maximum power available has been reduced by an amount equal to that previously being provided by the offline fuel cell power plant, and wherein the at least one microgrid controller identifies lower priority loads to shed and the at least one microgrid continues operating at reduced load capability.

In a further non-limiting implementation of any of the methods, the plurality of fuel cell power plants comprises a predetermined number of fuel cell power plants that is determined to satisfy system operational requirements for a power block system, and including:

adding at least one additional fuel cell power plant to the power block system, wherein each fuel cell power plant has a maximum operating load; and

during normal operation, signaling the predetermined number of fuel cell power plants and the at least one additional fuel cell power plant to operate at a reduced operating load that is less than the maximum operating load.

In a further non-limiting implementation of any of the methods, in response to one of the predetermined number of fuel cell power plants and the at least one additional fuel cell power plant going off-line to comprise an off-line fuel cell power plant, the method includes: providing power of the microgrid load shed by the off-line fuel cell power plant with the energy storage system; and increasing operating levels of any remaining fusel cell power plants from the reduced operating load to the maximum operating load such that the energy storage system stops discharging power and maintains a steady-state charge level.

In a further non-limiting implementation of any of the methods, the connection interface comprises a static transfer switch, the energy storage system includes one or more batteries and a bi-directional inverter, and including a transformer connected to the bi-directional inverter.

The present disclosure may include any one or more of the individual features disclosed above and/or below alone or in any combination thereof.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 schematically illustrates a selected portion of a fuel cell.

FIG. 2 is a schematic representation of a power block system associated with a utility grid and a microgrid.

FIG. 3 is similar to FIG. 2 and shows the power block system supplying power to the utility grid and the microgrid.

FIG. 4 is similar to FIG. 2 and shows the power block system supplying power the microgrid while the utility grid is offline.

FIG. 5 is a schematic representation of a N+1 power block configuration supplying power to the microgrid while the utility grid is offline.

FIG. 6 is similar to FIG. 5 but shows one fuel cell power plant as offline.

Like reference numbers and designations in the various drawings indicate like elements.

### DETAILED DESCRIPTION

The subject disclosure relates to a power block system comprised of a plurality of fuel cell power plants, an energy storage system, an energy management system, and a microgrid where during normal operation, the energy management system connects the at least one microgrid to the utility grid, and wherein in response to an occurrence of a predetermined grid event, such as a disturbance or outage for example, the energy storage system disconnects the microgrid from the utility grid and supplies an electrical load associated with the microgrid with power from the energy storage system and the plurality of fuel cell power plants.

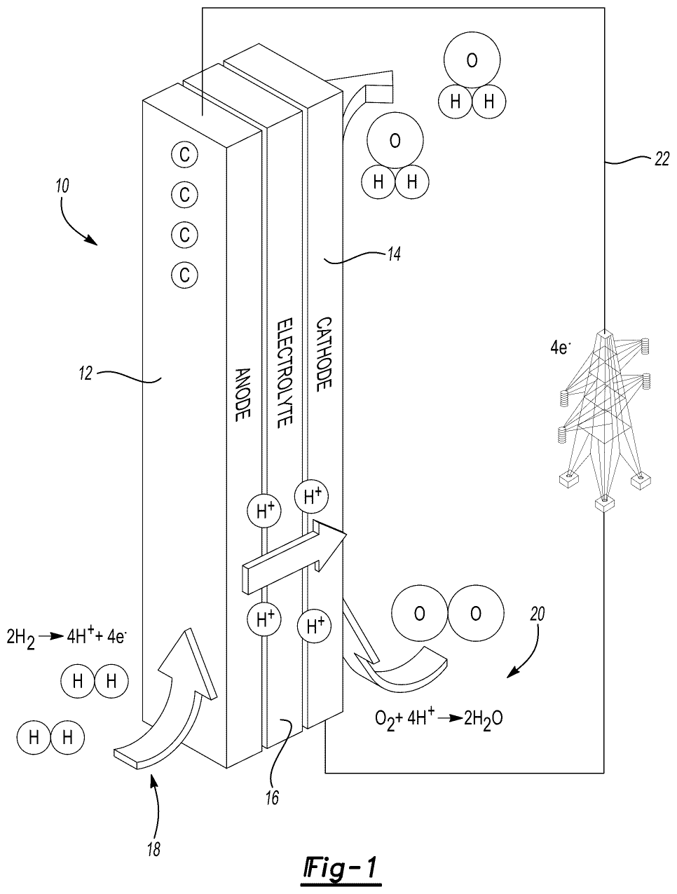

A fuel cell 10 is a power generation device which generates electricity—and, in many cases, heat—through an electrochemical process, which involves the interaction between hydrogen (or hydrogen-containing fuel) with oxygen. As shown in FIG. 1, each fuel cell 10 utilizes components such as an anode 12, a cathode 14, and an electrolyte 16 to generate electricity. Fuel containing hydrogen is channeled to the anode 12, as indicated at 18, where a catalyst splits the hydrogen atoms into positive hydrogen ions (protons) and negatively charged electrons. The function of the electrolyte 16 is to allow only the hydrogen ions (but not the electrons) to pass through it to the cathode 14. The hydrogen ions travel from the anode 12 to the cathode 14 through the electrolyte 16. At the cathode 14, the hydrogen ions that pass through electrolyte 16 combine with oxygen in the air to form water, as indicated at 20. The electrons travel along an external circuit 22 generating an electrical current.

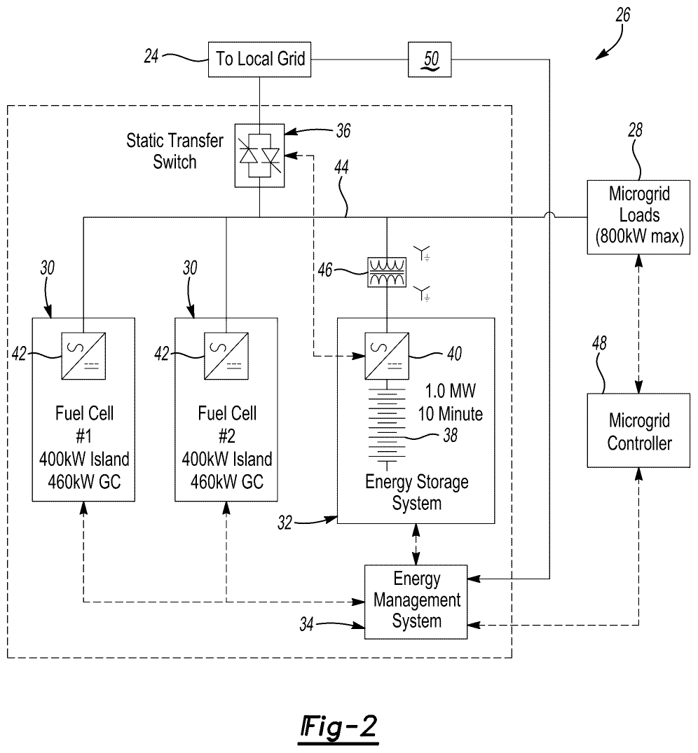

In implementations, a plurality of the fuels cells 10 may be stacked together to form a power plant unit, e.g., a PureCell® unit, which uses the electrochemical process for power generation for a utility grid 24 (FIG. 2), and which can be fueled by liquefied petroleum gas (LPG), natural gas, or hydrogen such that significantly lower emissions are emitted than conventional power plants using fossil fuels. In implementations, the PureCell® may comprise a phosphoric acid fuel cell (PAFC) unit for stationary applications. Stationary application means fixed at a particular site, compared to mobility and transport applications. Each PureCell® comprises a modular unit that may be configured to generate electricity up to 460 or 440 kilowatts (which can power approximately 340 average US households), plus both low-grade and high-grade heat.

In implementations, in addition to providing efficient, clean, and reliable baseload electric and thermal energy, these fuel cell power plants may be configured as a power block 26, as shown in FIG. 2, to also provide these benefits to a microgrid 28 in the event of a loss of the utility grid 24. This power block 26 may provide seamless transfer from utility grid operation to islanded microgrid operation and may leverage the fuel cell load dispatch capability to continuously supply highly variable microgrid loads. In implementations, the solution may be scalable from 800 kW to 5 MW.

In implementations, the power block 26 is designed and configured such that the maximum requirements for a microgrid load may always be met.

FIG. 2 shows one example implementation of a microgrid power block 26. In this implementation there are two fuel cell power plants 30 (additional power plants 30 may also be utilized as needed), an energy storage system (ESS) 32, an energy management system (EMS) 34, and a connection interface 36 to connect power to the utility grid 24.

In implementations, the ESS 32 may include one or more batteries 38 and a power conditioning system 40. In implementations, the batteries 38 may comprise Lithium Ferro-Phosphate batteries. In implementations, the power conditioning system 40 may comprise a bi-directional inverter.

In implementations, the connection interface 36 may comprise a breaker or may comprise a static transfer switch (STS), which is an automatic static switching device designed to transfer critical loads between two independent AC power sources without interruption or with a transfer time of less than a ¼ of a cycle, e.g., less than 4 ms.

In implementations, each fuel cell power plant 30 may include an inverter 42 that connects to a main line 44 that electrically connects to the utility grid 24 via the connection interface 36 and that also electrically connects to the microgrid 28. In implementations, a transformer 46 may connect the power conditioning system 40 of the ESS 32 to the main line 44.

Further, in implementations, the system may be scalable by adding fuel cell power plants 30 and increasing the size of the ESS 32.

In implementations, a microgrid controller 48 may interface between the microgrid 28 and the EMS 34.

In implementations, the microgrid controller 48 and/or the EMS 34 may comprise one or more controllers that may include one or more processors, memory, network devices, and input and/or output devices and/or interfaces. Such controllers may be a desktop computer, laptop computer, smart phone, tablet, or any other computing device. The interface may facilitate communication with the other systems and/or components of the network. The interfaces may include, for example but not limited to, one or more buses and/or other wired or wireless connections.

The one or more controllers may be a hardware device for executing software, particularly software stored in memory, and can be a custom made or commercially available processor, a central processing unit (CPU), an auxiliary processor among several processors associated with the computing device, a semiconductor based microprocessor (in the form of a microchip or chip set) or generally any device for executing software instructions. The input devices may include a keyboard, mouse, etc. The output device may include a monitor, speakers, printers, etc. The memory may include UVPROM, EEPROM, FLASH, RAM, ROM, DVD, CD, a hard drive, or other computer readable medium which may store data and/or other information relating to the planning and implementation techniques disclosed herein.

In implementations, the software in the memory may include one or more separate programs, each of which includes an ordered listing of executable instructions for implementing logical functions. The one or more controllers can be configured to collectively execute software stored within the memory, to communicate data to and from the memory, and to generally control operations of the computing device pursuant to the software. Software in memory, in whole or in part, is read by the processor, perhaps buffered within the processor, and then executed.

In implementations, the EMS 34 is configured to provide state-of-charge management of the energy storage system batteries in an “islanding” condition in which power generation for the microgrid 28 is disconnected from the main utility grid 24 in response to certain utility grid events. Utility grid events may include interruption and/or degradation of main grid power. In implementations, one or more data collection devices 50, such as sensors for example, are associated with the utility grid 24 and monitor and collect various data concerning grid operation, which is communicated to the ESS 32. In implementations, the grid data can be used to identify variations in electrical parameters of the grid 24, which can be used to identify changes to the electrical grid as compared to established grid operational criterions. In implementations, the need to disconnect the microgrid 28 from the utility grid 24 may be determined when at least one predetermined or selected grid criterion or event is met. For example, the predetermined grid event may comprise a grid disturbance causing voltage or frequency to fall outside a certain predetermined level or a complete power outage. Those skilled in the art who have the benefit of this description will be able to determine the one or more electrical parameters of the grid 24 that would be monitored and utilized for these purposes.

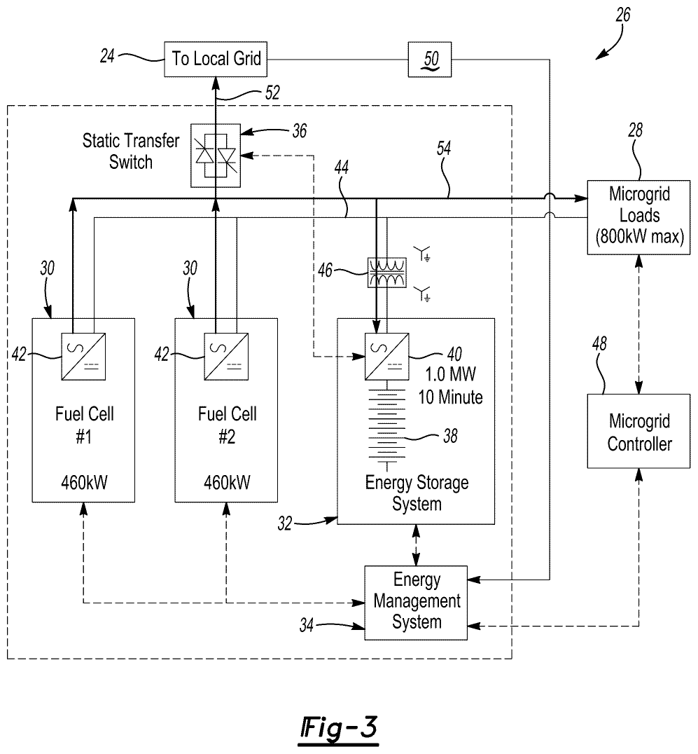

During normal grid-connected operation as shown in FIG. 3, the microgrid 28 is connected to the utility grid 24 (see 52) for the local electric system via the STS connection interface 36. The fuel cell power plants 30 are operating at a base load up to a rated load per power plant and serving facility electrical and thermal loads. In implementations, the fuel cell power plants 30 are operating at a base load of 400 kW (see FIG. 2) up to a rated load of 460 kW per power plant, for example. The fuel cell power plants 30 are also connected to the microgrid 28 (see 54). Further, during normal operation, the EMS 34 is maintaining a standby state-of-charge on the ESS 32 which is monitoring for a change in grid status.

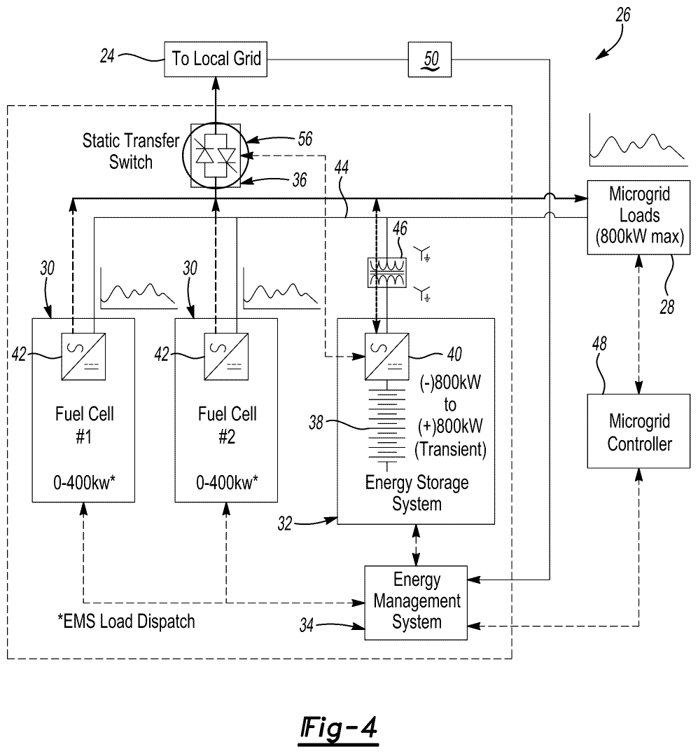

In the event of a grid fault, disturbance, or outage, the STS connection interface 36 will disconnect the microgrid 28 from the local utility grid 24 as shown at 56 in FIG. 4. In implementations, the STS connection interface 36 will disconnect the microgrid 28 from the local utility grid 24 in approximately ¼ of a cycle (4 ms), and thus the ESS 32 instantly and seamlessly continues supplying the microgrid load while regulating system voltage and frequency. This instant and seamless transition will occur smoothly and continuously, with no apparent interruptions to normal operation of connected loads as power is disconnected from the utility grid 24 and maintained to the microgrid 28.

In implementations, there are two modes of operation. In a first mode, the EMS 34 simultaneously commands the fuel cell power plants 30 to a power set point determined by the EMS where the fuel cell power plants 30 will share the microgrid load with the ESS 32 and stay in a P/Q mode without disconnection from the microgrid 28. In implementations, in a second mode, the EMS 34 will command the fuel cell power plants 30 to operate in an idle mode, where the fuel cell power plants 30 are disconnected from the microgrid 28 and only supply their internal, parasitic loads. The EMS 34 may then send power setpoints to the fuel cell power plants 30 to match the microgrid loads. The fuel cell power plants 30 will ramp up to the set points at a predetermined rate to transition from solely supplying power to the microgrid 28 by discharging the ESS 32 while the fuel cell power plants 30 are in idle mode, to supplying power to the microgrid 28 via the fuel cell power plants 30 while also re-charging the ESS 32. In implementations, the EMS 34 commands the fuel cell power plants 30 to ramp up to the power setpoints at a predetermined rate of 10 kW/sec, for example, which allows the ESS 32 to stop discharging and maintain a desired state-of-charge.

In implementations, as the microgrid load varies up or down, the ESS 32 will immediately produce or absorb power to maintain voltage and frequency. Further, in implementations, the EMS 34 will calculate new power setpoints to the fuel cell power plants 30 as necessary to maintain the desired ESS state-of-charge.

In implementations, depending on the size and complexity of the site electrical system for the utility grid 24, the microgrid controller 48 may be needed to isolate, segregate, and prioritize loads and coordinate utility interconnection. In implementations, to prevent overage, the microgrid controller 48 may allow the ESS 32 to charge while the fuel cell power plants 30 are commanded to reduce to a lower power setpoint to keep voltage output generally constant.

In implementations, the microgrid controller 48 can provide enhanced microgrid resiliency in the event one of the fuel cell power plants were to go off-line. In this case, the ESS 32 seamlessly and instantly picks up the load that was being carried by the faulted fuel cell power plant. In implementations, the energy management system 34 signals to the microgrid controller 48 that a maximum power available has reduced by an amount equal to that previously being provided by the offline fuel cell power plant. In implementations, the microgrid controller 48 may identify lower priority loads to shed and the microgrid 28 continues operating at reduced load capability. For example, for the configuration shown in

FIG. 4, the EMS 34 would signal to the site microgrid controller 48 that the maximum power available has reduced from the base load combined power for two fuel cell power plants 30, e.g. 800 KW, to half of the base load power, e.g., 400 kW. The microgrid controller 48 could then shed lower priority loads and the system would continue operating at reduced load capability.

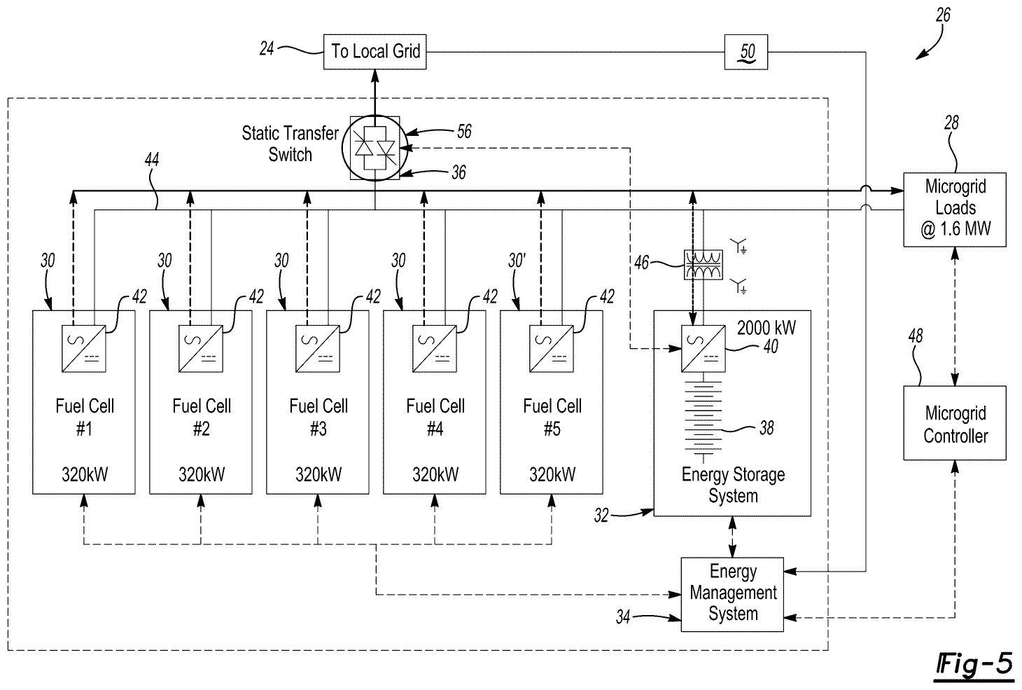

In certain implementations, the power block 26 may include a N+1 high reliability configuration. In mission critical applications requiring high reliability and full capacity microgrid power, the power block 26 may include N+1 redundancy. In implementations, the fuel cell power plants 30 comprises a predetermined number of fuel cell power plants 30 that is determined to satisfy maximum system operational requirements. For example, as shown in FIG. 5, the predetermined number of fuel cell power plants 30 that would satisfy maximum system operational requirements is four fuel cell power plants 30. In implementations of the N+1 redundancy, at least one additional fuel cell power plant 30′ is added to the system. Each fuel cell power plant 30 has a maximum operating load, and wherein, during normal operation, the EMS 34 signals the predetermined number of fuel cell power plants 30 and the at least one additional fuel cell power plant 30′ to operate at a reduced operating load that is less than the maximum operating load for each power plant.

In implementations, in response to one of the fuel cell power plants 30, 30′ going off-line, the ESS 32 provides power of the microgrid load shed by the off-line fuel cell, and the EMS 34 increases operating levels of any remaining fuel cell power plants from the reduced operating load to the maximum operating load such that the ESS 32 stops discharging power and maintains a steady-state charge level.

FIG. 5 depicts one example of a five unit fuel cell microgrid power block. However, instead of a maximum microgrid design load of 2000 kW, the microgrid maximum design load is limited to 1600 kW to achieve the N+1 redundancy. For this example, a worse case microgrid load of 1600 kW is assumed. The five fuel cell power plants 30, 30′ are each carrying 320 kW of microgrid load. The ESS 32 is regulating voltage and frequency and maintaining its desired state of charge.

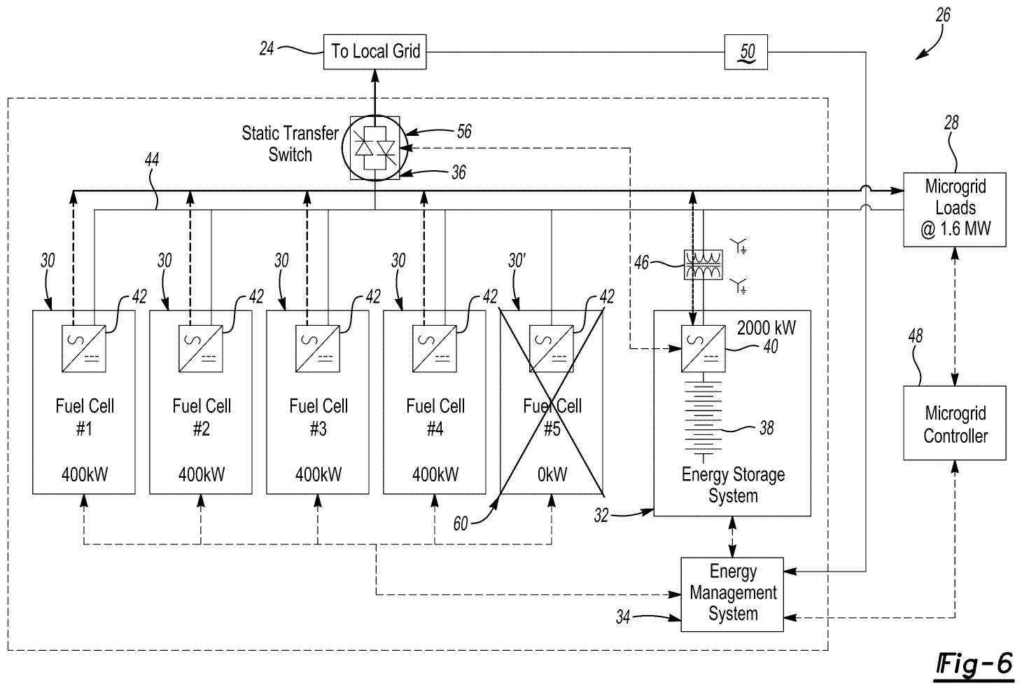

As shown in FIG. 6, a postulated fault takes one of the fuel cell power plants 30, 30′ off-line as indicated at 60. Instantly and seamlessly, the ESS 32 picks up the 320 kW of microgrid load shed by the off-line fuel cell power plant. The EMS 34 increases the load dispatch setpoints to the remaining fuel cell power plants from 320 kW to 400 kW. The remaining fuel cell power plants ramp up to their new power setpoints in a predetermined amount of time, e.g., 8 seconds, which allows the ESS 32 to stop discharging power and maintain its steady-state charge level.

The subject disclosure provides a flexible and scalable microgrid power block 26 that provides premium power in off-grid and microgrid applications requiring continuous and reliable power for critical loads. This is achieved while also providing seamless transitions to and from grid connected operations and excellent load following capability.

This addresses issues for prior systems with grid independent operation that were unable to allow multiple fuel cell power plants to operate in parallel. These prior system had a voltage/frequency (V/F) grid independent mode that forced the fuel cell power plants to follow the load of the customer which potentially enabled fuel starvation situations. For example, fuel starve events may happen if the customer turns on a load that is larger than a predetermined level, e.g., 54 kW/5 sec.

In implementations to address these issues, the subject disclosure provides for a fuel cell multi-unit load sharing system that utilizes an ESS 32, an EMS 34, and fuel cell power plants to seamless transition power to a microgrid during a utility grid outage. This type of implementation is ideal for microgrid and data center applications. During normal operation the fuel cell power plants will export a maximum power, e.g., 460 kW per power plant to the grid. In implementations, the consuming load will never be sized larger than 400 kW per fuel cell power plant. The ESS 32 will have a nominal state of charge (SOC) at a predetermined level, e.g., 86%, which leaves room for charging and discharging. In the event of a grid fault, a power connection interface 36, e.g., a circuit breaker (CB), automatic transfer switch (ATS) or static transfer switch (STS), will open to decouple the microgrid system from the main utility grid in a microgrid mode. Since the fuel cell output was 460 kW and consuming load is 400 kW, the ESS 32 will need to charge to absorb the excess power. The fuel cell power plants will remain in a P/Q mode, i.e., active power/reactive power mode, upon a grid fault and the ESS 32 will be the grid forming device in V/F mode. The fuel cell power plants and the ESS 32 will stay operational and seamlessly power the microgrid load and will lower their kW output from 460 kW per fuel cell power plant to the current consuming load. While in microgrid mode all load steps will be performed by the ESS, and the EMS will command the fuel cell power plants (via modbus TCP/IP) to ramp up to match the consuming load. The fuel cell power plants will only follow commands of the EMS if the CB, ATS or STS status signal shows that the device is open, which signals that the system is in microgrid mode.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

The preceding description is illustrative rather than limiting in nature. Variations and modifications to the disclosed examples may become apparent to those skilled in the art that do not necessarily depart from the essence of this invention.

What is claimed:

1. A system comprising:
a plurality of fuel cell power plants operable to supply power to a utility grid;
a connection interface operable to connect the plurality of fuel cell power plants to the utility grid;
an energy storage system operable to store power generated by the plurality of fuel cell power plants, wherein the energy storage system includes one or more batteries;
at least one microgrid connectable to the utility grid with the connection interface, wherein the energy storage system is operable to connect the at least one microgrid to the utility grid via the connection interface, and wherein in response to an occurrence of a predetermined grid event, the energy storage system is operable to disconnect the at least one microgrid from the utility grid; and
an energy management system, wherein during normal operation, the energy management system is operable to maintain a standby state-of-charge of the one or more batteries of the energy storage system, and in response to the occurrence of the predetermined grid event, the energy management system is operable to maintain a desired state-of-charge of the one or more batteries by controlling power setpoints for the plurality of fuel cell power plants.

2. The system of claim 1, wherein the connection interface comprises a static transfer switch.

3. The system of claim 1, wherein the energy storage system includes one or more batteries and a power conditioning system.

4. The system of claim 3, wherein the one or more batteries comprise lithium ferro-phosphate batteries and the power conditioning system comprises a bi-directional inverter.

5. The system of claim 1, wherein, during normal operation,
the plurality of fuel cell power plants are operable at a base load up to a rated load per fuel cell and are operable to provide electrical and thermal loads to the utility grid,
the energy storage system is operable to maintain the standby state-of-charge, and
the energy storage system is operable to monitor for a change in grid status.

6. The system of claim 1, wherein, in response to the predetermined grid event, the energy storage system is operable to instantly and seamlessly supply a microgrid load while regulating system voltage and frequency.

7. The system of claim 6, wherein the predetermined grid event comprises a grid disturbance or outage.

8. The system of claim 6, wherein, in response to the predetermined grid event, the energy management system is operable to simultaneously command the plurality of fuel cell power plants to an idle mode such that the plurality of fuel cell power plants only supply internal parasitic loads, and wherein the energy management system is operable to subsequently send the power setpoints to each fuel cell power plant to supply the microgrid load and is operable to command the plurality of fuel cell power plants to ramp up at a predetermined rate until the power setpoints are reached, such that the energy storage system is operable to stop discharging and maintain a desired state-of-charge.

9. The system of claim 8, wherein, as microgrid load varies up or down, the energy storage system is operable to immediately produce or absorb power to maintain voltage and frequency, and wherein the energy management system is operable to calculate and communicate updated power setpoints to each fuel cell power plant to maintain the desired state-of-charge for the energy storage system.

10. The system of claim 1, wherein the at least one microgrid includes at least one microgrid controller operable to prioritize loads, and wherein, in response to one of the plurality of fuel cell power plants going offline, at least one microgrid controller or the energy management system is operable to command the energy storage system to seamlessly and instantly pick up a load that was carried by an offline fuel cell power plant.

11. The system of claim 10, wherein the energy management system is operable to signal to the at least one microgrid controller that a maximum power available has reduced by an amount equal to that previously being provided by the offline fuel cell power plant, and wherein the at least one microgrid controller is operable to identify lower priority loads to shed such that the at least one microgrid continues operating at reduced load capability.

12. The system of claim 1, wherein the plurality of fuel cell power plants comprises a predetermined number of fuel cell power plants that is determined to satisfy system operational requirements, and wherein at least one additional fuel cell power plant is added to the system, and wherein each fuel cell power plant has a maximum operating load, and wherein, during normal operation, the energy management system is operable to signal the predetermined number of fuel cell power plants and the at least one additional fuel cell power plant to operate at a reduced operating load that is less than the maximum operating load.

13. The system of claim 12, wherein, in response to one of the predetermined number of fuel cell power plants and the at least one additional fuel cell power plant going off-line to comprise an off-line fuel cell power plant, the energy storage system is operable to provide power to a microgrid load shed by the off-line fuel cell power plant, and the energy management system is operable to increase operating levels of any remaining fuel cell power plants from the reduced operating load to the maximum operating load such that the energy storage system stops discharging power and maintains a steady-state charge level.

14. A method comprising:
suppling power to a utility grid with a plurality of fuel cell power plants;
connecting the plurality of fuel cell power plants to the utility grid via a connection interface;
storing power generated by the plurality of fuel cell power plants with an energy storage system including one or more batteries;
during normal operation, the energy storage system connects at least one microgrid to a utility grid via the connection interface; and
in response to an occurrence of a predetermined grid event, the energy storage system disconnects the at least one microgrid from the utility grid and supplies a microgrid load associated with the at least one microgrid, and an energy management system maintains a desired state-of-charge for the one or more batteries by communicating specific power setpoints to the plurality of fuel cell power plants.

15. The method of claim 14, wherein the predetermined grid event comprises a grid disturbance or outage, and wherein, in response to the predetermined grid event, the energy storage system:
immediately supplies the microgrid load while regulating system voltage and frequency, while also simultaneously commanding the plurality of fuel cell power plants to an idle mode such that the plurality of fuel cell power plants are supplying internal parasitic loads; and
subsequently sends power setpoints to each fuel cell power plant to supply the microgrid load and commands the plurality of fuel cell power plants to ramp up at a predetermined rate until the power setpoints are reached, and such that the energy storage system stops discharging and maintains the desired state-of-charge.

16. The method of claim 15, wherein, as microgrid load varies up or down, the energy storage system immediately produces or absorbs power to maintain voltage and frequency, and including calculating and communicating updated power setpoints to each fuel cell power plant as necessary to maintain the desired state-of-charge for the energy storage system.

17. The method of claim 14, wherein, in response to one of the plurality of fuel cell power plants going offline to comprise an offline fuel cell power plant, the energy storage system seamlessly and instantly picks up a portion of the microgrid load that was being carried by the offline fuel cell power plant, and including signaling at least one microgrid controller that a maximum power available has been reduced by an amount equal to that previously being provided by the offline fuel cell power plant, and wherein the at least one microgrid controller identifies lower priority loads to shed and the at least one microgrid continues operating at reduced load capability.

18. The method of claim 14, wherein the plurality of fuel cell power plants comprises a predetermined number of fuel cell power plants that is determined to satisfy system operational requirements for a power block system, and including:
adding at least one additional fuel cell power plant to the power block system, wherein each fuel cell power plant has a maximum operating load; and
during normal operation, signaling the predetermined number of fuel cell power plants and the at least one additional fuel cell power plant to operate at a reduced operating load that is less than the maximum operating load.

19. The method of claim 18, wherein, in response to one of the predetermined number of fuel cell power plants and the at least one additional fuel cell power plant going off-line to comprise an off-line fuel cell power plant, the method includes:
providing power of the microgrid load shed by the off-line fuel cell power plant with the energy storage system; and
increasing operating levels of any remaining fusel cell power plants from the reduced operating load to the maximum operating load such that the energy storage system stops discharging power and maintains a steady-state charge level.

20. The method of claim 14, wherein the connection interface comprises a static transfer switch, the energy storage system includes one or more batteries and a bi-directional inverter, and including a transformer connected to the bi-directional inverter.
